(19) United States
(12) Patent Application Publication
(10) Pub. No.: US 2012/0274305 A1
(43) Pub. Date: Nov. 1, 2012

(54) Voltage Regulator and Voltage-Regulator-Equipped Oscillation Circuit

(75) Inventors: Masaaki Kamiya, Shiroi-shi (JP); Ryuji Ariyoshi, Shiroi-shi (JP)

(73) Assignee: INTERCHIP CORPORATION, Shiroi-shi (JP)

(21) Appl. No.: 13/456,266

(22) Filed: Apr. 26, 2012

(30) Foreign Application Priority Data
Apr. 28, 2011 (JP) 2011-102454

(51) Int. Cl. G05F 3/02

(52) U.S. Cl. 323/311

(57) ABSTRACT

A voltage regulator comprises an N type depletion MOS transistor having a drain connected to the positive electrode side of a power supply, a source connected to a stabilizing capacitor, and a gate receiving a constant reference voltage, and has an output terminal at the source of the N type depletion MOS transistor. In this simple circuit configuration, the voltage regulator can markedly reduce a noise carried on an output voltage.

The entire disclosure of Japanese Patent Application No. 2011-102454 filed Apr. 28, 2011 is expressly incorporated by reference herein.

### TECHNICAL FIELD

This invention relates to a voltage regulator realizing a low output voltage noise and a voltage-regulator-equipped oscillation circuit realizing a low phase noise.

### BACKGROUND ART

In a CMOS integrated circuit, when circuit elements are required a stable operation under a voltage fluctuation of power supply, they are of ten used with a voltage regulator. As such a voltage regulator, a circuit as shown in FIG. 8 has so far been used extensively. Such a voltage regulator VI is composed of a reference voltage generator 1, an operational amplifier 2, and a stabilizing capacitor 3. The voltage regulator VI operates by functions of the operational amplifier 2 that compares a reference voltage Vref, which is the output of the reference voltage generator 1, and the output voltage VREG of the voltage regulator VI, and equalizes these two voltages. In this manner, the voltage regulator VI shows excellent constant voltage characteristics. Thus, the voltage regulator VI is universally used as a constant voltage source.

As a publicly known document which discloses this type of voltage regulator, Patent Document 1, for example, can be named.

### CITATION LIST

### Patent Literature

Patent Document 1: JP-A-2010-277192

### SUMMARY OF INVENTION

### Technical Problem

The voltage regulator VI according to the conventional technology as described above, however, uses the reference voltage generator 1 and the operational amplifier 2 which are both sources of noise. Thus, the voltage regulator VI is defective in that the noise level of its output voltage VREG is high.

A crystal oscillator or the like incorporates the voltage regulator when dependence of an oscillation frequency or a vibrator drive current on the power supply voltage is required to suppress. In this case, if the output noise of the voltage regulator VI is large, it appears as a phase noise in the output signal of the oscillation circuit, deteriorating the output signal quality.

As the speed of communications has become faster and faster in recent years, there has been a growing demand for the reduction of the phase noise. Thus, the noise reduction of the voltage regulator output has been more important than before.

The present invention has been accomplished in the light of the above-mentioned problems of the conventional technology. It is an object of the present invention to provide a voltage regulator which can markedly reduce an output noise of voltage regulator by a simple circuit configuration; and also provide a voltage-regulator-equipped oscillation circuit which has the voltage regulator, but involves a minimal phase noise.

### Solution to Problem

Aspects of the present invention for attaining the above object will be described in connection with the use of an N type as a depletion MOS transistor. Thus, the negative electrode side of the power supply is taken as a ground electrode, and its potential is called a ground potential, while the positive electrode side of the power supply is taken as a hot electrode, and its voltage is called a power supply voltage. In regard to the aspects of the present invention, when a P type is used as the depletion MOS transistor, the same description will apply, if the positive electrode of the power supply is taken as the ground, while the negative electrode side of the power supply is taken as a hot electrode. Thus, a description of the P type is omitted.

An aspect of the present invention which attains the above object is a voltage regulator comprising an N type depletion MOS transistor having a gate connected to a constant reference voltage, having a source connected to a stabilizing capacitor, and having a drain connected to a power supply voltage.

According to the present aspect, a voltage regulator generates a constant voltage by utilizing the pinch-off characteristics of the N type depletion MOS transistor. Since it does not contain an operational amplifier, one of noise sources in the conventional voltage regulator, a noise due to the operational amplifier can be eliminated. That is, the noise level of the output voltage of the voltage regulator can be reduced.

The reference voltage applied to the gate of the N type depletion MOS transistor is preferably a ground potential. When the ground potential is utilized as the reference voltage in the voltage regulator, the voltage regulator of the present invention can be comprised without an operational amplifier and a reference voltage generator, which are the main noise sources in the conventional voltage regulator. Thus, an output voltage with a very low noise can be obtained.

The voltage regulator can use a reference voltage generator comprised with other N type depletion MOS transistor and a current-voltage converting element; the drain of the other N type depletion MOS transistor is connected to a power supply voltage, and the source of the other N type depletion MOS transistor is connected to the current-voltage converting element. In this case, the reference voltage Vref is supplied from the point of connection between the source of the other N type depletion MOS transistor and the current-voltage converting element. The current-voltage converting element of the reference voltage generator can be a resistor, a MOS transistor, or a combination of the resistor and the MOS transistor.

In the reference voltage generator, a plurality of the other depletion MOS transistors and/or the current-voltage converting elements are used with a plurality of switching means, whereby the reference voltage Vref can be varied via the switching means. By this configuration, the output of the voltage regulator can be adjusted easily for a target constant voltage. The switching means can be preferably formed, for example, by utilizing a fuse or a nonvolatile memory.

Another aspect of the present invention is a voltage-regulator-equipped oscillation circuit, in which an oscillation circuit is connected as the load circuit for the voltage regulator.

According to the present aspect, the voltage regulator can supply a low noise constant voltage to the oscillation circuit. Thus, the oscillation circuit can generate an oscillation signal having a low phase noise which can apply a high speed communication.

### Advantageous Effects of Invention

According to the present invention, a voltage regulator can be constructed by utilizing the pinch-off characteristics of the N type depletion MOS transistor. An operational amplifier used in a conventional voltage regulator is not used. Thus, the noise level of the output voltage can be reduced markedly. As a result, the phase noise of an output signal can be reduced in a crystal oscillation circuit or the like combined with the voltage regulator of the present invention. Since the circuit configuration of the voltage regulator is simple, moreover, the effect is also obtained that the area occupied by the voltage regulator in an integrated circuit can be rendered small.

### BRIEF DESCRIPTION OF DRAWINGS

FIG. 1 is a circuit diagram showing a voltage regulator according to a first embodiment of the present invention.

FIG. 2 is a graph showing the voltage-current characteristics of the output of the voltage regulator according to the present invention.

FIG. 3 is a graph showing the output noise characteristics of the voltage regulator according to the present invention in comparison with prior art.

FIG. 4 is a circuit diagram showing a voltage regulator according to a second embodiment of the present invention.

FIG. 5 is a circuit diagram showing a voltage regulator according to a third embodiment of the present invention.

FIG. 6 is a circuit diagram showing a voltage regulator according to a fourth embodiment of the present invention.

FIG. 7 is a circuit diagram showing a voltage-regulator-equipped oscillator according to a fifth embodiment of the present invention.

FIG. 8 is a circuit diagram showing a voltage regulator according to the prior art.

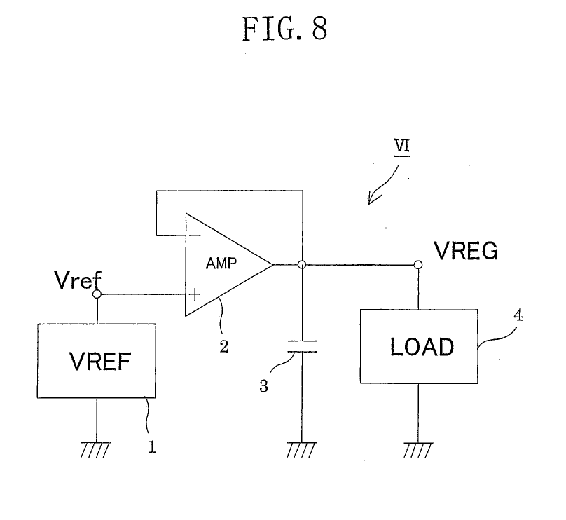

### DESCRIPTION OF EMBODIMENTS

Embodiments of the present invention will now be described in detail with reference to the accompanying drawings. In these drawings, the same parts are assigned the same numerals, and duplicate explanations are omitted.

### First Embodiment

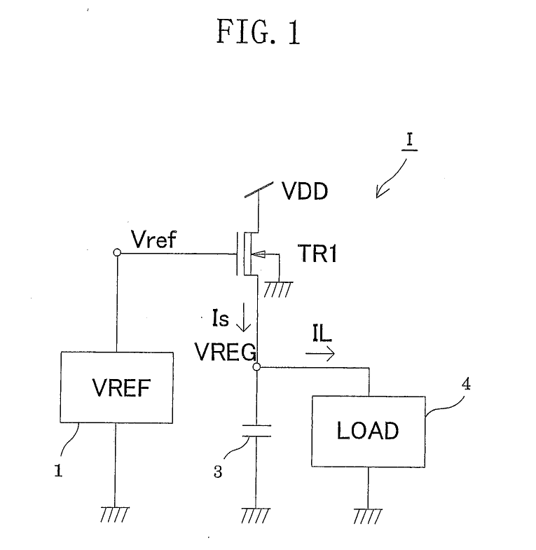

FIG. 1 is a circuit diagram showing a voltage regulator according to a first embodiment of the present invention. As shown in this drawing, the voltage regulator I is composed of a reference voltage generator 1, an N type depletion MOS transistor TR1, and a stabilizing capacitor 3. The gate of the N type depletion MOS transistor TR1 is biased with a reference voltage, its drain is connected to a power supply voltage VDD, and its source has connected thereto the stabilizing capacitor 3 and a load circuit 4. As noted here, the voltage regulator I according to the present embodiment does not use an operational amplifier, one of noise sources in conventional voltage regulator, and thus can eliminate a noise coming from the operational amplifier. That is, the noise level of the output voltage VREG of the voltage regulator I can be reduced.

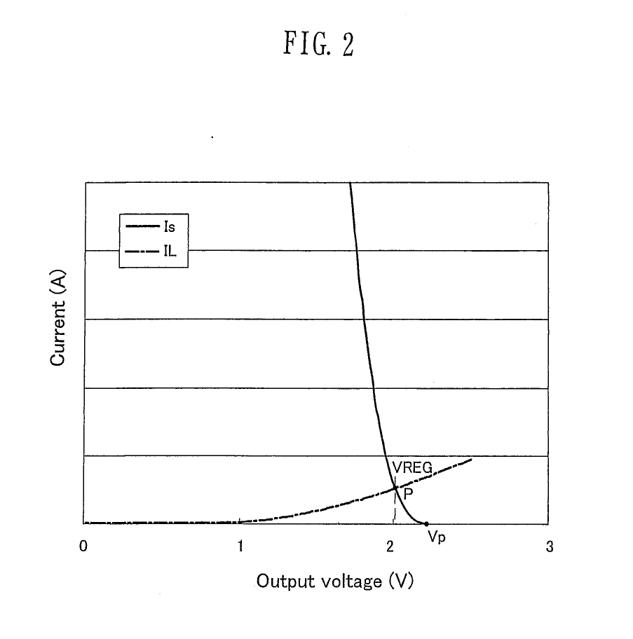

According to the present embodiment, a voltage regulation is achieved by the pinch-off characteristics of the N type depletion MOS transistor TR1. In this connection, a more detailed explanation will be offered using FIG. 2.

FIG. 2 is a graph showing the voltage-current characteristics of the output of the voltage regulator I according to the present embodiment, with the output voltage as abscissas and the current as ordinates. In the drawing, a solid line represents the characteristics of the source current Iₛ of the N type depletion MOS transistor TR1, and a dashed dotted line represents the characteristics of a load current IL.

As will be clear by reference to FIG. 2, if the power supply voltage VDD is equal to or more than a pinch-off voltage V_{P} of the N type depletion MOS transistor TR1, the source current Iₛ shown in FIG. 2 does not depend on the power supply voltage VDD. Thus, an output voltage of the voltage regulator VREG, which is given at the intersection point P of the source current Iₛ and the load current IL (in the case of FIG. 2, it is in the neighborhood of 2V), is held constant under changes in the power supply voltage VDD. If the current of the depletion MOS transistor TR1 Iₛ shows sharp increase below pinch-off voltage Vp, the output voltage VREG can be also held in almost constant under changes in the load current IL. It follows, therefore, that the voltage regulator I functions as a constant voltage source, if the power supply voltage VDD is equal to or more than the pinch-off voltage Vₚ.

Consequently, the voltage regulator I according to the present embodiment can hold the output voltage VREG constant without using an operational amplifier. Since it does not use an operational amplifier which works as a noise source, the voltage regulator I can keep the noise level of the output voltage VREG low.

Furthermore, the voltage regulator according to the present embodiment has a circuit configuration that the load circuit 4 is connected to the source of the N type depletion MOS transistor TR1. This is so called a source follower structure. Thus, a noise produced in the N type depletion MOS transistor TR1 is suppressed by a negative feedback operation. Under the bias conditions where the N type depletion MOS transistor TR1 is performing a regulator action, most of current flowing in the N type depletion MOS transistor TR1 passes though away form the MOS interface. Thus, the MOS current is less affected by the MOS interface instability which is a noise source. That is, the transistor can be operated as a low noise device comparable to an FET.

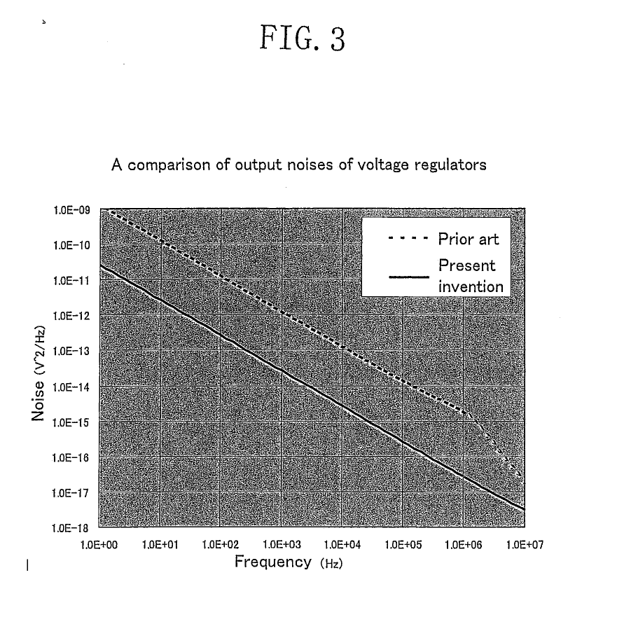

FIG. 3 is a graph showing the output noise characteristics of the voltage regulator I according to the present embodiment in comparison with prior art. In the drawing, a solid line represents the output noise characteristics of the voltage regulator I according to the present embodiment, while a dashed line represents the output noise characteristics of the voltage regulator VI according to the prior art. As will be clear by reference to the drawing, an output noise is found to be suppressed at any of the frequencies in the voltage regulator I according to the present embodiment as compared with the voltage regulator VI according to the prior art.

### Second Embodiment

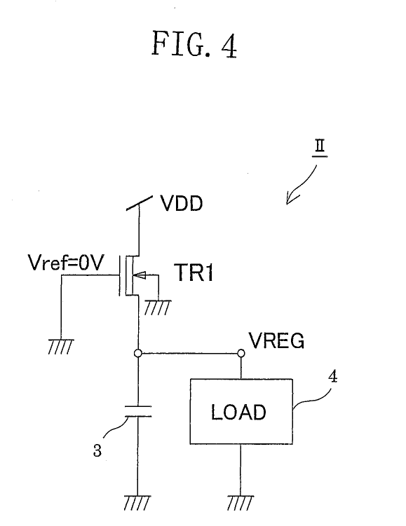

FIG. 4 is a circuit diagram showing a voltage regulator according to a second embodiment of the present invention. As shown in the drawing, a voltage regulator II according to the present embodiment sets a reference voltage Vref, which is applied to the gate of an N type depletion MOS transistor TR1, to a ground potential.

Since the ground potential can be the most stable reference voltage, the noise level of the output voltage of the voltage regulator II can be minimized.

In the present embodiment, under the conditions where the gate of the N type depletion MOS transistor TR1 is biased at the ground potential, the pinch-off voltage Vₚ needs to be set at a value equal to or a little higher than the constant voltage which a load circuit 4 requires. This setting is done by the IC fabrication process.

### Third Embodiment

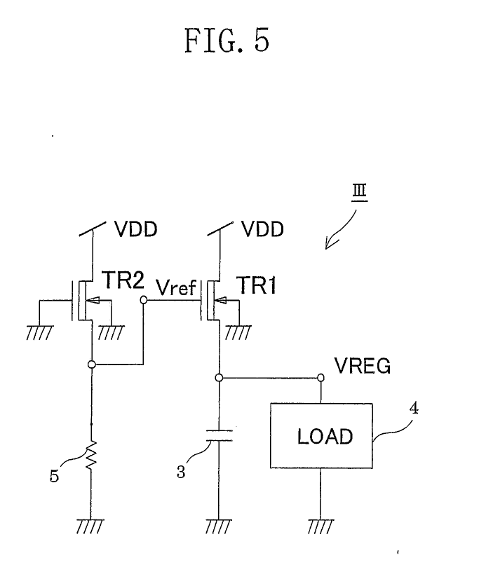

FIG. 5 is a circuit diagram showing a voltage regulator according to a third embodiment of the present invention. As shown in the drawing, a voltage regulator III according to the present embodiment is designed such that a reference voltage Vref applied to the gate of an N type depletion MOS transistor TR1 is defined by an N type depletion MOS transistor TR2 having a gate grounded, and a resistor 5 connected to the source of the transistor TR2. That is, the resistor 5 in the present embodiment functions as a current-voltage converting element of a reference voltage generator.

According to the present embodiment, the reference voltage Vref can be adjusted by changing the size of the N type depletion MOS transistor TR2 or the resistance value of the resistor 5. Thus, the reference voltage Vref can be varied if a plurality of the N type depletion MOS transistors TR2 or a plurality of the resistors 5 and a switching measures such as fuses are incorporated in the circuit. If an output voltage VREG shifts from the target constant voltage because of fluctuations in the IC fabrication process, therefore, the output voltage of the voltage regulator can be tuned by the fuse cutting.

### Fourth Embodiment

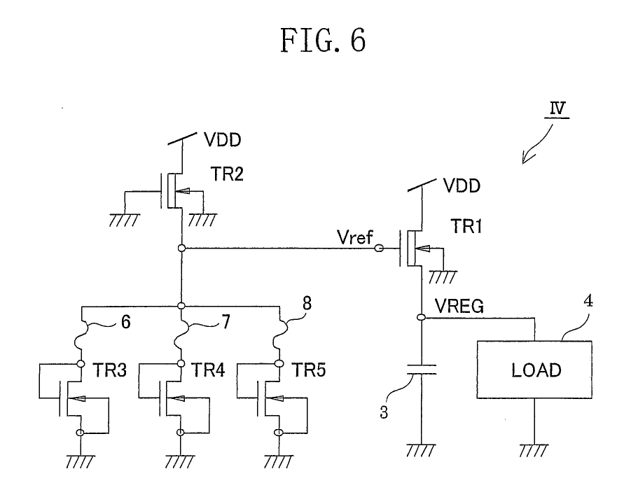

FIG. 6 is a circuit diagram showing a voltage regulator according to a fourth embodiment of the present invention. As shown in the drawing, a voltage regulator IV according to the present embodiment is designed such that a reference voltage Vref applied to the gate of an N type depletion MOS transistor TR1 is defined by an N type depletion MOS transistor TR2 having a gate grounded, and NMOS transistors TR3, TR4, TR5 connected to the source of the transistor TR2. That is, the NMOS transistors TR3 to TR5 in the present embodiment functions as current-voltage converting elements of a reference voltage generator.

According to the present embodiment, an output voltage VREG can be adjusted by cutting fuses 6, 7, 8 and selecting the NMOS transistors TR3, TR4, TR5.

In the present embodiment, the voltage regulator is configured such that a plurality of (three in the drawing) the current-voltage converting elements (the NMOS transistors TR3 to TR5) are connected to the single N type depletion MOS transistor TR2. However, this is not limitative. Needless to say, for example, the voltage regulator may be of a configuration in which a plurality of the N type depletion MOS transistors TR2 with fuses are provided and connected to a current-voltage converting element. In the present embodiment, the gate of the N type depletion MOS transistor TR2 is grounded. However, this is not limitative, and the gate may be connected to other reference voltage or the reference voltage Vref produced by itself.

In the first, third and fourth embodiments equipped with the reference voltage generator, moreover, in order to reduce the noise level in these embodiment, it is desirable to set the reference voltage Vref lower than the output voltage VREG. For a low noise voltage regulator, a combination of a reference voltage generator having a low reference voltage Vref and the N type depletion MOS transistor TR1 having a high pinch-off voltage is suitable.

### Fifth Embodiment

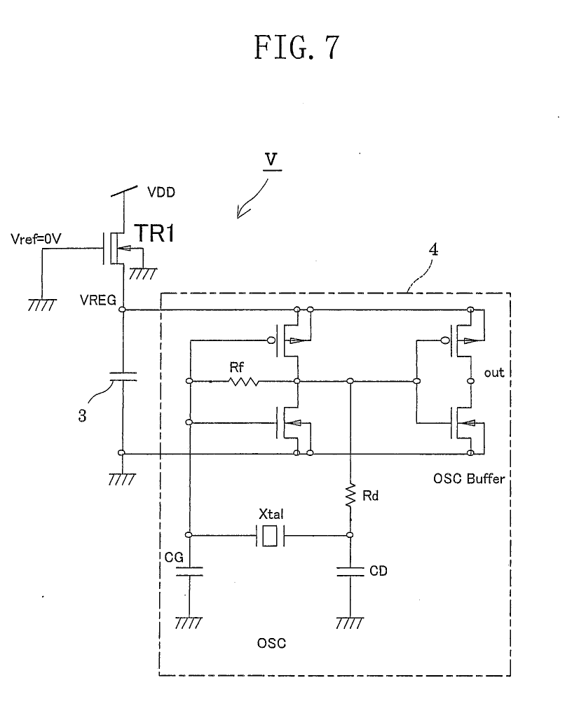

FIG. 7 is a circuit diagram showing a voltage-regulator-equipped oscillator according to a fifth embodiment of the present invention. In the voltage-regulator-equipped oscillator V according to the present embodiment, a crystal oscillator is connected as the load circuit 4 in the voltage regulator II according to the second embodiment.

According to the present embodiment, the output noise of the voltage regulator II is markedly reduced, so that the phase noise of the oscillation circuit can be also reduced.

In FIG. 7, the crystal oscillation circuit is illustrated as the oscillation circuit, but needless to say, this is not limitative. Any oscillation circuit can be used, without particular limitations, and the voltage-regulator-equipped oscillator having such an oscillation circuit can exhibit the same actions and effects. Voltage-regulator-equipped oscillators using the voltage regulators I, III according to the first and third embodiments can also obtain the same actions and effects.

Each of the above embodiments shows the use of the N type depletion MOS transistor TR1 or the like, but this is not limitative. If a P type depletion MOS transistor is used, it follows that the voltage regulator outputs a constant voltage referred to the positive electrode of the power supply. In an embodiment corresponding to the second embodiment shown in FIG. 4, the gate of the P type depletion MOS transistor will be connected to the positive electrode of the power supply, its drain will be connected to the negative electrode of the power supply, and its source will be connected to the load circuit. In other embodiment having a reference voltage generator, its reference voltage will be a voltage referred to the positive electrode of the power supply.

### INDUSTRIAL APPLICABILITY

The present invention is useful when applied to an oscillator in which the output noise of a voltage regulator causes a phase noise and phase jitters.

### REFERENCE SIGNS LIST

I to IV Voltage regulator
1 Reference voltage generator
4 Load circuit
TR1 N type depletion MOS transistor
VDD Power supply voltage
Vref Reference voltage
VREG Output voltage

1. A voltage regulator, comprising:
a depletion MOS transistor having a gate to which a constant reference voltage is applied, having a source to which a stabilizing capacitor and a load circuit are connected, and having a drain which is connected to a positive electrode side of a power supply if the depletion MOS transistor is of an N type, or which is connected to a negative electrode side of the power supply if the depletion MOS transistor is of a P type.

2. The voltage regulator according to claim 1, wherein
the reference voltage applied to the gate is a voltage on the negative electrode side of the power supply if the depletion MOS transistor is of the N type, or is a voltage on the positive electrode side of the power supply if the depletion MOS transistor is of the P type.

3. The voltage regulator according to claim 1, wherein
the reference voltage is produced by a reference voltage generator comprising other depletion MOS transistor and a current-voltage converting element,
a drain of the other depletion MOS transistor is connected to the positive electrode side of the power supply if the other depletion MOS transistor is of an N type, or is connected to the negative electrode side of the power supply if the other depletion MOS transistor is of a P type, and
a source of the other depletion MOS transistor is connected to the current-voltage converting element.

4. The voltage regulator according to claim 3, wherein
the current-voltage converting element constituting the reference voltage generator comprises a resistor, a MOS transistor, or a combination of the resistor and the MOS transistor.

5. The voltage regulator according to claim 3, wherein
a plurality of the other depletion MOS transistors and/or the current-voltage converting elements constituting the reference voltage generator are provided along with a plurality of switching means, and
the reference voltage can be varied via the switching means.

6. A voltage-regulator-equipped oscillation circuit, comprising an oscillation circuit connected as the load circuit for the voltage regulator according to claim 1.
